(19) United States
(12) Patent Application Publication
(10) Pub. No.: US 2024/0351340 A1
(43) Pub. Date: Oct. 24, 2024

(54) LIQUID CARTRIDGE AND MANUFACTURING METHOD OF THE SAME

(71) Applicant: CANON KABUSHIKI KAISHA, Tokyo (JP)

(72) Inventors: SHUICHI HASEGAWA, Kanagawa (JP); Yukuo Yamaguchi, Tokyo (JP); KEISUKE IINUMA, Kanagawa (JP); JUNICHIRO IRI, Kanagawa (JP)

(21) Appl. No.: 18/634,790

(22) Filed: Apr. 12, 2024

(30) Foreign Application Priority Data
Apr. 19, 2023 (JP) 2023-068339

(51) Int. Cl. B41J 2/175

(52) U.S. Cl. CPC B41J 2/17559; B41J 2/17513

(57) ABSTRACT

A liquid cartridge includes a first member, a second member bonded to the first member. A resin for bonding the first member and the second member is formed between the first member and the second member. A buffer configured to store resin is formed between the first member and the second member. The buffer has an opening that leads to a side surface of the liquid cartridge.

### BACKGROUND

### Field of the Disclosure

The present disclosure relates to a liquid cartridge and a manufacturing method of the same.

### Description of the Related Art

A liquid discharge apparatus that discharges a liquid to a medium, such as paper, for producing a record includes a liquid cartridge for storing the liquid (ink) to be discharged.

Japanese Patent Application Laid-Open No. 2019-051597 discusses a method for manufacturing liquid cartridges using an in-mold assembly and molding technique. Specifically, Japanese Patent Application Laid-Open No. 2019-051597 discusses a method for manufacturing a liquid cartridge by fitting together a container part and a lid in a mold and pouring a melted resin into a gap formed between the container part and the lid to bond these two members.

According to Japanese Patent Application Laid-Open No. 2019-051597, if the melted resin is excessively poured into a gap between two members (a container part and a lid), the excess melted resin may leak from the gap between the two members because there is no part (buffer) that can store the excess melted resin. Even though a buffer is provided, if there is no means for checking the state in the buffer, the melted resin may be charged in excess of the capacity of the buffer. In that case, the excess melted resin may also leak, which leads to reduction in yield.

### SUMMARY

In view of this, the present disclosure is directed to providing a liquid cartridge that enables a visual check of the state in the buffer in the case of manufacturing the liquid cartridge using an in-mold assembly and molding technique, and a manufacturing method of the same.

According to an aspect of the present disclosure, a liquid cartridge includes a first member, and a second member bonded to the first member. A resin for bonding the first member and the second member is formed between the first member and the second member. A buffer is configured to store resin and is formed between the first member and the second member. The buffer has an opening that leads to a side surface of the liquid cartridge.

Further features of the present disclosure will become apparent from the following description of exemplary embodiments with reference to the attached drawings.

### BRIEF DESCRIPTION OF THE DRAWINGS

FIG. 1 is a perspective view of a liquid cartridge according to a first exemplary embodiment.

FIG. 2 is an exploded perspective view of the liquid cartridge according to the first exemplary embodiment.

FIG. 3 is a perspective view of a conventional liquid cartridge.

FIG. 4 is a cross-sectional view of FIG. 3 taken along line A-A.

FIGS. 5A to 5D are schematic diagrams illustrating the state of a melted resin in the first exemplary embodiment.

FIGS. 6A to 6D are schematic diagrams illustrating the state of a melted resin at openings in the first exemplary embodiment.

FIGS. 7A to 7C are schematic diagrams illustrating charging paths of a melted resin in the first exemplary embodiment.

FIG. 8 is a schematic view of a liquid cartridge according to a second exemplary embodiment.

### DESCRIPTION OF THE EMBODIMENTS

Hereinafter, exemplary embodiments of the present disclosure will be described in detail. In the following description, components having identical functions are given identical reference signs in the drawings, and description thereof may be omitted.

### First Exemplary Embodiment

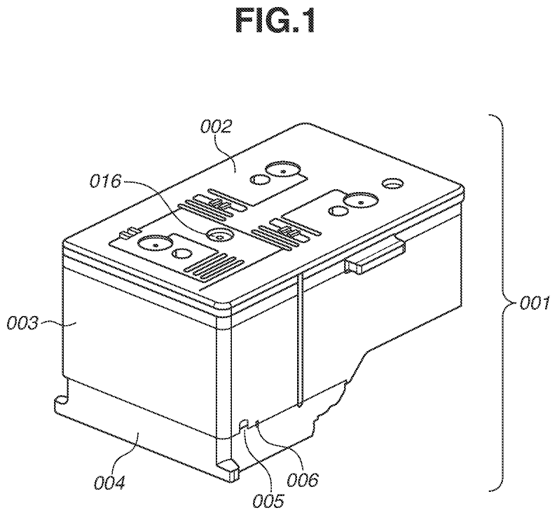

FIG. 1 is a perspective view of a liquid cartridge 001 according to the first exemplary embodiment. The liquid cartridge 001 is constructed mainly from a first member 002, a second member 003, and a third member 004. The second member 003 has a second opening 005 described below in detail. Between the second member 003 and the third member 004, a first opening 006 described below in detail is formed.

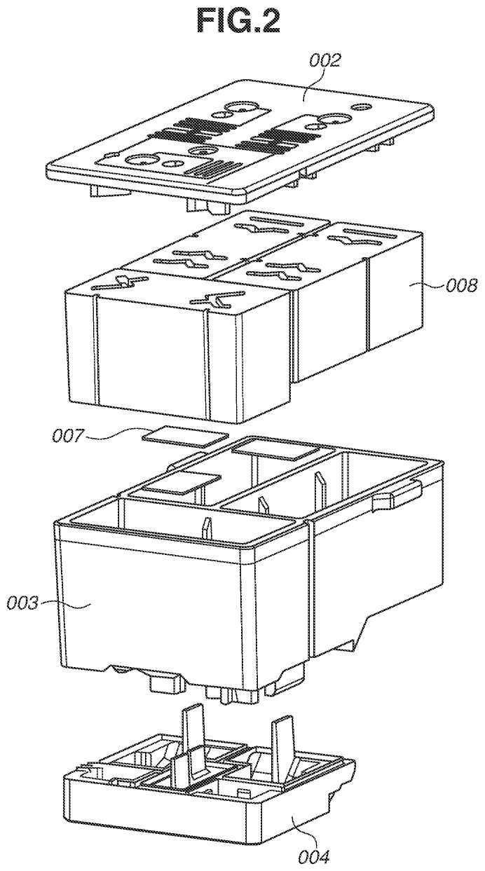

FIG. 2 is an exploded perspective view of the liquid cartridge 001 illustrated in FIG. 1. The liquid cartridge 001 includes a filter 007 and an absorber 008 therein. The filter 007 catches dust and the like in the liquid. The absorber 008 holds the liquid by capillary action.

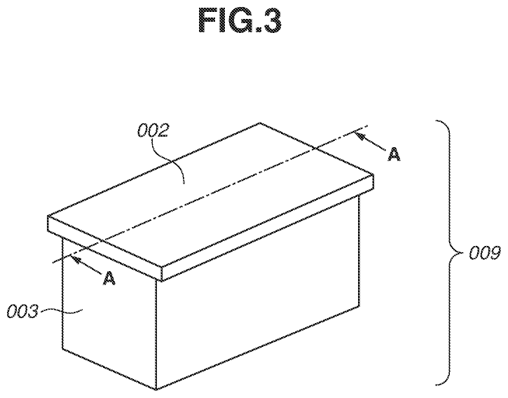

FIG. 3 is a schematic perspective view of a conventional liquid cartridge 009. The conventional liquid cartridge 009 is constructed mainly from a first member 002 and a second member 003.

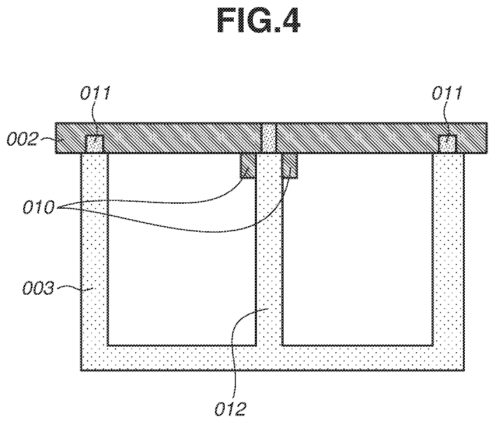

FIG. 4 is a cross-sectional view of the conventional liquid cartridge 009 illustrated in FIG. 3 taken along line A-A. In the liquid cartridge 009, the first member 002 and the second member 003 are bonded together by pouring a below-described melted resin 013 into a bonding groove 011 formed in the first member 002. In addition, projection parts 010 are provided on the first member 002 to suppress misalignment of the two members 002/003 at the time of bonding.

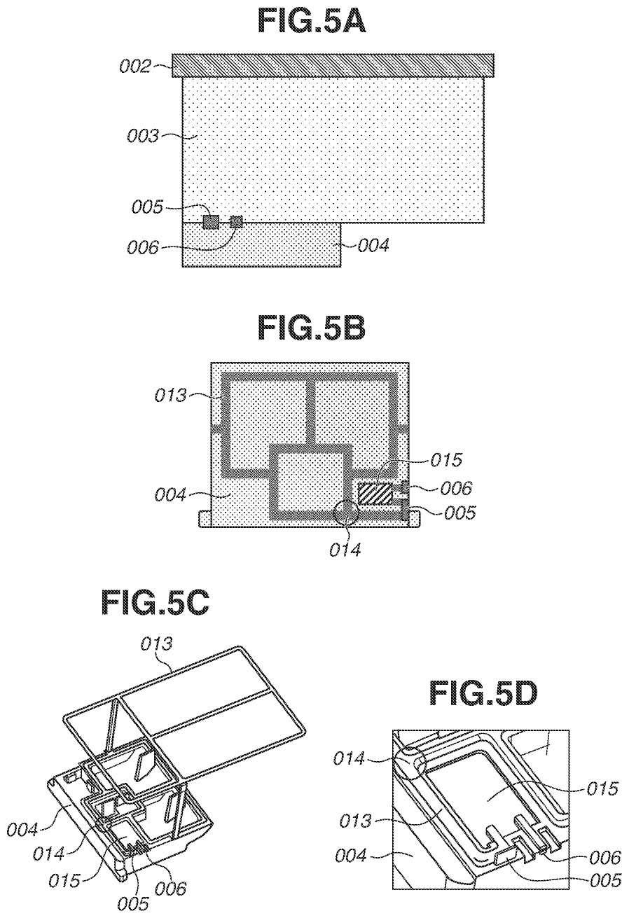

FIG. 5A is a side view of the liquid cartridge 001 illustrated in FIG. 1. FIG. 5B is a plan view of a bonding surface of the third member 004 to the second member 003. FIG. 5C is a schematic diagram illustrating the state of the melted resin 013. FIG. 5D is a schematic enlarged view of a buffer 015 and its vicinity.

As illustrated in FIG. 5A, the liquid cartridge 001 has the second opening 005 and the first opening 006 formed at positions that can be seen from the outside. The second opening 005 is formed ahead of a final charging position 014 of the melted resin 013 illustrated in FIG. 5B, and it is possible to check whether the melted resin 013 has reached the final charging position 014 by viewing inside through the second opening 005. The final charging position 014 here refers to a position to which the melted resin 013 is to be charged where it is possible to determine that the members have been bonded without problem, which is the target position to be reached by the melted resin 013. The term “final” does not deny that the melted resin 013 having reached the final charging position 014 further flows onward to the second opening 005 and the like. Thus, the “final charging position” can also be called “charging target position”. The melted resin 013 used in the present exemplary embodiment may further reach the second opening 005 or the buffer 015 after having reached the final charging position 014.

The first opening 006 is formed ahead of the buffer 015, and the state of the melted resin 013 in the buffer 015 can be checked by viewing inside through the first opening 006. The state of the buffer can thereby be visually checked from the outside, which makes it possible to visually check the state of the melted resin 013 and suppress overflow of the melted resin 013 from a gap between the two members.

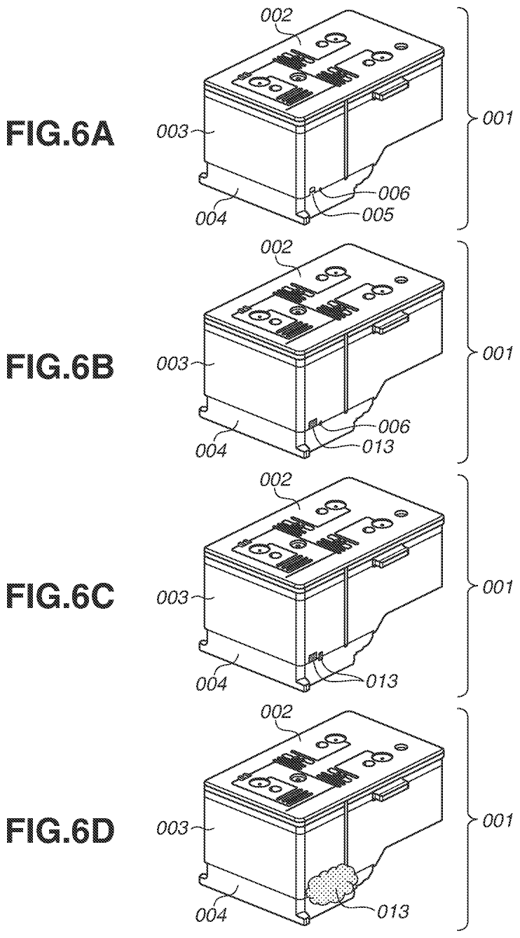

FIG. 6A is a schematic diagram illustrating a case where the melted resin 013 cannot be visually checked through the second opening 005 and the first opening 006 of the liquid cartridge 001 illustrated in FIG. 1. If the melted resin 013 cannot be visually checked through the second opening 005, it is determined that the poured melted resin 013 has not reached the final charging position 014 and that there is a possibility that a bonding failure has occurred.

FIG. 6B is a schematic diagram illustrating a case where the melted resin 013 can be visually checked through the second opening 005. In such a case, it is determined that the poured melted resin 013 has reached the final charging position 014 and that the members have been bonded without problem.

FIG. 6C is a schematic diagram illustrating a case where the melted resin 013 can be visually checked through both the second opening 005 and the first opening 006. In such a case, it is determined that the poured melted resin 013 has reached the final charging position 014 and that the members have been bonded without problem.

FIG. 6D is a schematic diagram illustrating a case where the melted resin 013 has been excessively poured and the melted resin 013 is overflowing from both the second opening 005 and the first opening 006. In such a case, it is determined that a bonding failure has occurred.

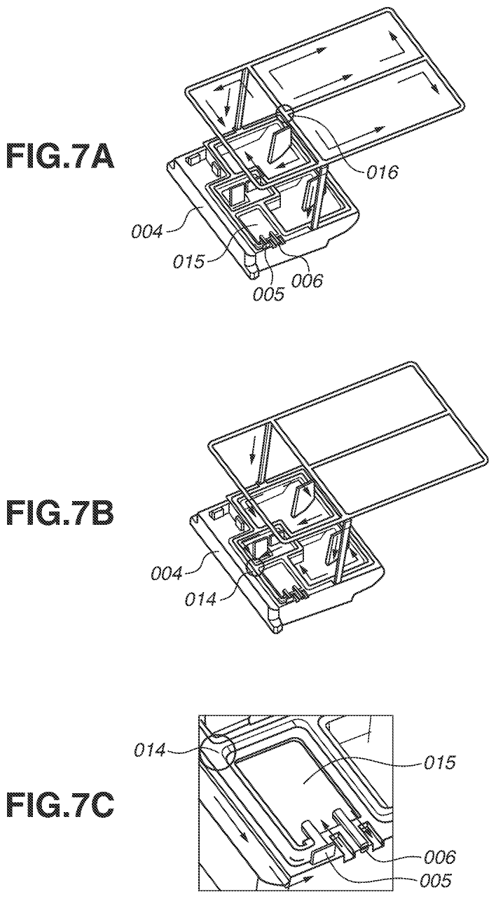

FIGS. 7A to 7C are schematic diagrams illustrating flow paths of the melted resin 013. First, the melted resin 013 is poured through a gate 016 illustrated in FIG. 7A and flows as shown by arrows. Thereafter, the melted resin 013 flows toward the final charging position 014 as shown by arrows in FIG. 7B. As illustrated in FIG. 7C, the melted resin 013 then passes through the second opening 005 to reach the buffer 015, the excess melted resin 013 is stored in the buffer 015, and the melted resin 013 having not been stored in the buffer 015 reaches the first opening 006.

### Second Exemplary Embodiment

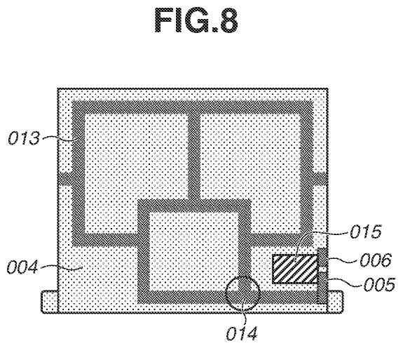

The second exemplary embodiment will now be described with reference to FIG. 8. FIG. 8 is a schematic diagram illustrating the second exemplary embodiment, which is equivalent to FIG. 5B. In the present exemplary embodiment, a buffer 015, a second opening 005, and a first opening 006 are integrated together.

Even in such a case, as in the first exemplary embodiment, the state of the buffer 015 can be visually checked through the first opening 006, it is thus possible to visually check the state of the melted resin 013 and suppress overflow of the melted resin 013 from a gap between the two members.

Hereinafter, the present disclosure will be described in detail taking examples. However, the present disclosure is not limited to these examples.

### Example 1

FIGS. 5A to 5D are schematic perspective diagrams illustrating a method of visually checking bonding of the molded members according to the first exemplary embodiment of the present disclosure. The liquid cartridge 001 in the present disclosure may be separated into a plurality of liquid storage tanks or may be provided with a single-color liquid storage tank. For example, the first member 002 and the second member 003 are bonded together using the melted resin 013 such that different liquids of colors, such as, for example, cyan (C), magenta (M), and yellow (Y), can be separated into individual storage tanks. In such a case of storing a liquid of, for example, black (BK) in a single-color liquid storage tank, no different liquids are separated.

The first member 002, the second member 003, and the third member 004 are bonded using the melted resin 013 to form the liquid cartridge 001 including such liquid storage tank(s). At that time, in the manufacturing method by molding, the second opening 005 through which the state of the melted resin 013 can be visually checked is provided on the extension line of the final charging position 014, so that it is possible to prevent leakage, overflow, and shortage of the melted resin 013.

In addition, in the manufacturing method by molding, the first opening 006 through which the state of the melted resin 013 can be visually checked is provided on the extension line of the buffer 015, so that it is possible to suppress abnormal charging of the melted resin 013.

FIG. 5A illustrates the state where the first member 002, the second member 003, and the third member 004 are bonded by the melted resin 013 and the second opening 005 through which the state of the melted resin 013 can be visually checked is provided on the extension line of the final charging position 014. The first opening 006 is provided on the extension line of the first opening 006 such that abnormal charging of the melted resin 013 can be detected by visual checking. It is desirable to check the abnormal charging of the melted resin 013 by performing visual checking or mechanical checking using image processing or the like.

As the melted resin 013, a thermoset resin higher in fluidity than the first member 002, the second member 003, and the third member 004 is desirably used.

FIG. 5B is a diagram illustrating the bonding surface of the third member 004 to the second member 003 on which the second opening 005 is provided on the extension line of the final charging position 014 of the melted resin 013. The buffer 015 is provided on the extension line of the second opening 005. The first opening 006 is provided on the extension line of the buffer 015.

Providing the second opening 005 on the extension line of the final charging position 014 has an effect of enabling a visual check of the state of the melted resin 013. In addition, providing the first opening 006 on the extension line of the buffer 015 has an effect of enabling a visual check of abnormal charging of the melted resin 013 and also has an effect of causing a gas to escape during charging of the resin.

For example, when the state of the melted resin 013 is visually checked and the melted resin 013 has not reached the second opening 005, there is a possibility that leakage, overflow, or shortage of the melted resin 013 has occurred. Although it is possible to visually check the leakage or overflow of the melted resin 013 at the outer part of the liquid cartridge 001 in a completely molded state, there is no means for checking internal leakage or overflow. The second opening 005 is thus provided to enable a visual check of the state of the melted resin 013, and the minimum required charging of the resin is checked. In a normal state of the second opening 005, the second opening 005 is fully filled with the melted resin 013. In an abnormal state of the second opening 005, the second opening 005 is hollow because the melted resin 013 has not reached the second opening 005 as described above.

As for the first opening 006, when the state of the melted resin 013 is visually checked and the melted resin 013 is leaking or overflowing from the first opening 006, there is a possibility that abnormal charging of the melted resin 013 has occurred. This is abnormal charging in excess of the maximum charging amount of the melted resin 013, and the abnormal resin charging is observed.

The buffer 015 is a part that absorbs charging variation amount of the melted resin 013 for bonding the combined molded members, and the use purpose of the buffer 015 is different from the use purpose of the bonding groove 011 that constitutes a path for pouring the melted resin 013.

If the charging amount of the melted resin 013 varies in the direction toward the minimum amount, the melted resin 013 flows into the second opening 005 that is provided on the extension line of the final charging position 014 unless there has occurred resin leakage, overflow, or shortage in the path for charging the melted resin 013. It is thereby possible to visually check the state.

If the charging amount of the melted resin 013 varies in the direction toward the maximum amount, however, the melted resin 013 flows to the second opening 005 that is provided on the extension line of the final charging position 014 unless there has occurred resin leakage, overflow, or shortage in the path for charging the melted resin 013. The state can be visually checked as in the case where the charging amount varies in the direction toward the minimum amount, but it is necessary to absorb the variation in the melted resin 013 in the direction toward the maximum amount.

Providing the buffer 015 on the extension line of the second opening 005 thereby makes it possible to absorb the charging variation amount of the melted resin 013 in the direction toward the maximum amount. The buffer 015 thus has an effect of enabling a visual check of the state of the melted resin 013 and an effect of absorbing the charging variation amount of the melted resin 013 by being provided on the extension line of the second opening 005 provided on the extension line of the final charging position 014.

In a normal state of the first opening 006, the second opening 005 is fully filled with the melted resin 013 and the first opening 006 is hollow, accordingly. Alternatively, the first opening 006 is fully filled with the melted resin 013 if the second opening 005 is fully filled with the melted resin 013 and the melted resin 013 varies in the direction toward the maximum amount. In an abnormal state of the first opening 006, the second opening 005 is fully filled with the melted resin 013 and the melted resin 013 is leaking or overflowing from the first opening 006.

FIG. 5C is a perspective view of the bonding surface of the third member 004 to the second member 003, illustrating the state where the members are bonded by the melted resin 013.

FIG. 5D is an enlarged perspective view of the buffer 015 and its vicinity illustrated in FIG. 5C. The first opening 006 has an effect of enabling a visual check of abnormal charging of the melted resin 013 and also has an effect of causing a gas to escape during resin charging. A gas vent as a typical gas escape discharges a gas generated from a melted resin and the air in the mold. A typical gas vent has a thickness of about 0.02 mm because it is merely required to cause the gas and the air to escape. As a gas vent in the present exemplary embodiment, the first opening 006 through which the occurrence of abnormal charging can be visually checked is used to cause a gas generated from the melted resin 013 to escape. As compared to a typical gas vent, the first opening 006 has an opening size of about 1 mm×1 mm in order not only to cause the gas generated from the melted resin 103 and the air in the bonding groove to escape but to visually check the abnormal charging.

FIGS. 6A to 6D are schematic perspective diagrams illustrating the presence or absence of a melted resin at the openings in the first exemplary embodiment of the present disclosure. FIG. 6A is a perspective view of an example of the liquid cartridge 001 in the present disclosure, illustrating the state where the molded members, the first member 002, the second member 003, and the third member 004, are combined together without the melted resin 013. Due to the absence of the melted resin 013, the second opening 005 and the first opening 006 are hollow.

FIG. 6B is a perspective view of an example of the liquid cartridge 001 in the present disclosure, illustrating the state where the molded members, the first member 002, the second member 003, and the third member 004, are bonded together by the melted resin 013. The second opening 005 is filled with the melted resin 013, and the first opening 006 is hollow. Since the second opening 005 is filled with the melted resin 013, the bonding state is normal.

FIG. 6C is a perspective view of an example of the liquid cartridge 001 in the present disclosure, illustrating the state where the molded members, the first member 002, the second member 003, and the third member 004, are bonded together by the melted resin 013. The second opening 005 and the first opening 006 are filled with the melted resin 013. Since the second opening 005 is filled with the melted resin 013 and the first opening 006 is also filled with the melted resin 013 without leakage or overflow of the melted resin 013, the bonding state is normal.

FIG. 6D is a perspective view of an example of the liquid cartridge 001 in the present disclosure, illustrating the state where the molded members, the first member 002, the second member 003, and the third member 004, are bonded together by the melted resin 013. Since the melted resin 013 is overflowing from the first opening 006, the bonding state is a state with abnormal charging. For example, the abnormal charging means that the resin is charged in excess of a prescribed charging amount due to a failure in a molding machine due to an abnormal pressure or the like during injection of a melted resin. In this case, in the exemplary embodiment of the present disclosure, the melted resin 013 leaks from the first opening 006 that is the final charging position, and the melted resin 013 may spread to the side surfaces of the liquid cartridge 001.

### Example 2

FIG. 8 is a schematic perspective diagram illustrating a method for enabling a visual check of molding and bonding according to the second exemplary embodiment of the present disclosure. FIG. 8 is a diagram illustrating the bonding surface of a third member 004 to a second member 003, where a second opening 005, a buffer 015, and a first opening 006 are integrated.

In the second exemplary embodiment, the part extending from the second opening 005 in the first exemplary embodiment of the present disclosure described above in FIG. 5 is eliminated, and the second opening 005 is integrated with the buffer 015. The part extending from the buffer 015 is also eliminated, and the first opening 006 is integrated with the buffer 015. Although the extending parts are eliminated, the second opening 005 and the buffer 015 can be integrated by providing the buffer 015 through the second opening 005 in a path for pouring a melted resin 013. As for the first opening 006, the buffer 015 and the first opening 006 can also be integrated by providing the first opening 006 through the buffer 015. With the integrated configuration, it is possible to visually check the state of the melted resin 013 through the second opening 005, absorb charging variation of the melted resin 013 in the buffer 015, and visually check the state of abnormal charging of the melted resin 013 through the first opening 006. This configuration is effective in a case where there is a restriction on the molded member size or melted resin amount.

According to the present disclosure, it is possible to provide, in manufacturing a liquid cartridge using an in-mold assembly and molding technology, a liquid cartridge that enables a visual check of the state of the buffer, and a manufacturing method of the same.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-068339, filed Apr. 19, 2023, which is hereby incorporated by reference herein in its entirety.

What is claimed is:

1. A liquid cartridge comprising:
a first member;
a second member bonded to the first member;
a resin formed between the first member and the second member to bond the first member and the second member; and
a buffer configured to store resin and formed between the first member and the second member,
wherein the buffer has an opening that leads to a side surface of the liquid cartridge.

2. The liquid cartridge according to claim 1, wherein the opening is provided so that a state of the resin in the buffer can be visually checked from outside the liquid cartridge.

3. The liquid cartridge according to claim 1, further comprising a charging target position, as a target position for charging the resin, defined between the first member and the second member,
wherein the resin is formed up to the charging target position.

4. The liquid cartridge according to claim 3, wherein the opening is formed ahead of the charging target position.

5. The liquid cartridge according to claim 1, wherein the opening is formed ahead of the buffer.

6. The liquid cartridge according to claim 1, wherein the buffer is configured to receive the resin charged therein.

7. The liquid cartridge according to claim 4, wherein another opening different from the opening is formed between the buffer and the charging target position.

8. The liquid cartridge according to claim 1, wherein the opening is formed with a size of 1 mm×1 mm on the side surface of the liquid cartridge.

9. The liquid cartridge according to claim 1, wherein the opening and the buffer are integrated.

10. The liquid cartridge according to claim 1,
wherein the first member is a lid part of the liquid cartridge, and
wherein the second member is a container part configured to store a liquid of the liquid cartridge.

11. A manufacturing method of a liquid cartridge including a first member and a second member, the manufacturing method comprising:
pouring a melted resin into a gap between the first member and the second member, the gap being formed when the first member and the second member are brought into contact with each other in a mold; and
removing the first member and the second member from the mold,
wherein, in the pouring, the melted resin is poured into at least to a buffer formed between the first member and the second member, and
wherein, after the removing, visually checking a state of the melted resin in the buffer through an opening provided in the buffer.
